(19) United States
(12) Patent Application Publication
(10) Pub. No.: US 2006/0002759 A1
(43) Pub. Date: Jan. 5, 2006

(54) Quick change pole end attachment connector

(76) Inventors: Gary Palmer Blackman, Carmel Valley, CA (US); Kent Brian Zilliox, Carmel Valley, CA (US)

Correspondence Address: Kent Zilliox, 4 Buena Vista Del Rio #A, Carmel Valley, CA, 93924, US

(21) Appl. No.: 11/171,837

(22) Filed: Jun. 29, 2005

Related U.S. Application Data
(60) Provisional application No. 60/585,247, filed on Jul. 1, 2004.
(60) Provisional application No. 60/667,909, filed on Mar. 25, 2005.

(51) Int. Cl. F16B 7/10

(52) U.S. Cl. 403/109.3

(57) ABSTRACT

A quick change pole end connector apparatus for quickly connecting one or more devices to a long handled pole. The inventive apparatus can be secured between the outer end of a pole handle and a device to be attached. In one embodiment, a quick change pole end connector can be built to fit swimming pool pole handles, which are typically 1.15 inch outside diameter, and have a pair of opposing spring release connector pins, which are snapped into a matching pair of holes in a device to be connected. The invention can be built to allow a user to quickly connect a pole end device at an angle relative to the pole. In another embodiment, a quick change pole end connector apparatus can be made to accommodate two or more devices to be attached to a pole at the same time.

### RELATED APPLICATIONS

This Utility Patent Application for “Quick Change Pole End Attachment Connector” filed on Jun. 29, 2005 is a Continuation-in-Part to U.S. Provisional Patent Applications Nos. 60/585,247 filed Jul. 1, 2004 and 60/667,909 filed Mar. 25, 2005 and claims the benefit of the priority dates of those two U.S. Provisional Patent Applications. The aforementioned U.S. Provisional Patents Applications Nos. 60/585,247 and 60/667,909 hereby incorporate by reference in their entirety and for all purposes into this Patent Application.

This Patent Application filed on Jun. 29, 2005 is also hereby cross-referenced to and incorporates by reference the separate Utility Patent Application titled, “Locking Hinge Connector Apparatus” invented by the same two co-inventors Gary Blackman and Kent Zilliox, and filed on the same date of filing with the present Patent Application for “Quick Change Pole End Attachment Connector.”

### FIELD OF THE INVENTION

The present invention relates to a device for quickly changing devices attached to a handle, and more particularly for attaching devices at various orientations to the attached handle.

### BACKGROUND OF THE INVENTION

There are many different manual operations that can be performed by those people interested in using a device attached to an extension pole. However, with common extension poles, many devices for pole attachment, such as swimming pool skimmers, are designed in a fixed direction from the line of the pole, often in straight line with the direction of the pole. However, such common fixed-direction pole attachment devices are typically limited to a single orientation of usage, some of which may not be feasible for certain desired operations, or are strenuous for a person using long handle pole devices.

For instance, in the swimming pool industry a main component of routine maintenance is removal of debris anywhere from within the body of water in the pool. Debris removal is typically accomplished with the use of a skimming apparatus, which is commonly comprised of a telescoping pole, with a handle at one end, and at the other end of the pole is typically a net device attached to its outer end. This simple net device has been a standard tool in the swimming pool industry for many years and is commonly referred to as a “skimmer” or “skimmer net.” It is used by pool owners and professional maintenance personnel alike. The device often contains few or no moving parts, yet it offers several design features, enabling it to capture debris floating close by or adhering the side of the pool, debris floating farther out on the water surface, debris suspended anywhere below the surface and debris lying on the bottom of the pool.

The net (skimmer net) device may consist of a specialized hoop with a net attached to the entire perimeter of the hoop and an industry-standard attachment handle, designed to attach to any industry-standard pole. The net may vary in depth from very shallow to quite deep, depending on the amount of debris it's intended to capture and contain.

The hoop itself, which is often more rectangular than circular, may have sharp edges on three of its sides, enabling the device to scrape debris adhering to the side of the pool and debris lying on the bottom of the pool. The sharp edges on either side of the hoop are used to scrape and capture debris adhering to the side of the pool, while the sharp leading edge is used to scrape and capture debris lying on the bottom of the pool. Debris scraped in this manner mostly flows into the attached net and is immediately captured and contained therein.

The orientation of the hoop opening in many common skimmers, is generally parallel with the attached pole, similar to a butterfly net, and is useful in several types of orientations. For example, when scraping debris from the side of the pool, this orientation requires the user to stand very close to the edge of the pool and operate the device from directly above. In this manner, one side of the hoop is held against the side of the pool and moved forward. Line-of-sight visibility between the user and the skimmer/poolside contact point is somewhat obscured by overhanging tile or coping surrounding typical pools. This orientation also requires the user to apply force in two directions: pressing the device against the side of the pool to maintain the scraping action and pushing the device forward, all while slightly leaning over the edge of the pool to maintain visual contact with the process.

In another type of usage with a pole and skimmer, the parallel orientation of the hoop opening,to the attached pole enables the user to push the device along the bottom of the pool so its sharp leading edge can scrape debris into the attached net. During this bottom-scraping operation, the user pushes the device from a point on the bottom nearest to him outward to the limit of the reach of the attached pole. The device is then pulled back toward the user, pushed back down against the bottom of the pool, then out again, away from the user. The process is often repeated until the debris lying of the bottom of the pool is collected.

The parallel orientation of the hoop opening to the attached pole also enables the user to collect debris both floating on the surface of the water and suspended below the surface. The user can manipulate the device to capture debris in a side-to-side motion, a lifting motion or a downward motion. While effective, the user must accomplish these side-to-side and up-and-down motions from the end of a long pole. This cantilevered operation of the pole can be quite fatiguing, since it places reversed-leverage forces on the user. Thus there is a need for the inventive pole connection apparatus to allow for at least one device to be connected at a non-linear angle relative to the handle, such as perpendicular to a pole handle, since its additional pole orientation allow these routine maintenance tasks to be accomplished more quickly and with less physical effort.

### SUMMARY OF THE INVENTION

The apparatus is designed to simultaneously reduce back strain and fatigue and increase the effectiveness of long pole handle and attachment operations, although there are many other uses and benefits. The quick change connection apparatus in a most basic form comprises two main connection portions, typically at a non-linear angle relative to each other, thus changing the direction of operation of the device to be attached, relative to the direction of the handle, such as in the example of usage with a pool skimmer basket connected ninety degrees relative to a pole handle. Other types of handles besides straight poles can be used with the invention, although pole handles are used commonly herein as examples in describing some possible usages of the invention. A short handle body with a hand grip could also be made suitable to work with the invention as could other handle types which are known or can be developed by those skilled in the art.

In a quick change pole end connector embodiment for a swimming pool skimmer, the apparatus can connect to many kinds of industry-standard skimming device attachments. The pole connector apparatus can be secured between the outer end of a telescoping pole and a skimmer device. In this example, the male connector of an industry-standard skimmer connects to the female side of the apparatus. The male side of the apparatus, in turn, connects to the female connector of any industry-standard pole. The user can easily connect and disconnect various attachment tools and devices, allowing him to switch between desired tools such as various skimmer nets and scrub brushes very quickly. This speed and ease of the connecting and disconnecting operation, while convenient for pool owners, is especially important for pool maintenance professionals, who must account for their time on each job.

During a side-scraping operation with the device in a perpendicular, ninety-degree orientation, the device enables the user to walk ahead of the skimmer, trailing the pole behind him, pulling the skimmer along the sidewall of the pool. By walking a path a foot or two from the side of the pool, the pole is angled away from the pool (toward the side), which, with the resulting angle of attack, automatically keeps the skimmer pressed against the side while it scrapes debris into the net.

Pulling rather than pushing the skimmer around the perimeter of the pool allows the operation to proceed more quickly. In addition, pulling the skimmer in only one direction, requires less force to be applied and relieves back strain, compared to the conventional method without an angled connector, of holding the pole in a vertical orientation and pushing the skimmer through the water. The increased speed made capable with the angled connector, has the additional benefit of creating a temporary swirling current within the pool. This swirling action helps consolidate debris floating farther out on the pool surface, enabling more efficient capture.

Ninety-degree or perpendicular orientation, and other angles of significantly nonlinear dimensions between the skimmer to the pole can also enhance capture of debris floating near the center potion of the surface of the water. In this operation the skimmer is tossed through the air to land beyond the debris. The skimmer is then pulled back in, toward the user, with its opening facing the direction of travel. In this manner, any debris floating between the user and the landing point of the skimmer is captured and retained in the skimmer net.

In yet another highly useful embodiment, two or more devices can be attached at the same time, such as a floatation device and a skimmer can both be attached to some embodiments of the inventive apparatus, which is then in turn attached to such a long poled handle. Then, with the apparatus turned such that the skimmer faces upwards, out of the water, the pole is used to push the apparatus with skimmer and float far out across the surface of the pool to a desired location. Next the pole handle is rotated to allow the skimmer to extend downwards into the water, and the floating skimmer and apparatus can easily then be pulled back across the surface, gathering the desired floating leaves or such debris.

If the user requires the skimmer hoop opening to be retuned to a linear or parallel orientation, he simply disconnects the non-linear connection device from the pole and from the skimmer net, and reconnects the skimmer net directly to the pole in the parallel position. Since parallel orientation is required for at least the bottom scraping operation, it is anticipated the user will use the skimmer in both orientations during an entire pool cleaning operation.

The device's male end is built to fit the size and dimensions to connect to any industry-standard pole. The female end of a pole connector apparatus is built for the correct size and dimensions to accept many industry-standard skimmers or other maintenance devices.

The connector apparatus can have numerous embodiments. In the swimming pool industry, the various embodiments are mostly related to the standard pool cleaning type pole connectors of approximately 1.125 inches diameter. In other industries, the various embodiments may use other connector types. For example, the connectors can be made to accommodate attachments common to many tasks, such as threaded connectors. Furthermore, the device can be manufactured in various sizes and specifications, depending on its intended use. The male and female connection portions of the device can embody various shapes. The male and female connectors in versions intended for use in the swimming pool industry are industry standard to fit virtually any standard pole or skimmer. In uses contemplated for other industries, the device can function as described in various configurations and shapes. In the preferred embodiment for use in the swimming pool industry, said apparatus including the male and female connector ends are made of molded plastic and the spring connector is made of nylon-type molded plastic. The female connector can also be made of aluminum tubing, of industry standard dimensions. Other materials, such as metal, wood, plastic, Plexiglas, wood, rubber, or any material suitable for construction and durable enough for usage of the device, can also be employed.

### BRIEF DESCRIPTION OF THE DRAWINGS

FIG. 1 shows a right angled pole end connector for pool cleaning where a long handled pole is connected to one end and a skimmer net is connected to the opposite end.

FIG. 2 shows a right angled quick change pole end connector with a male end including industry standard spring locking pins and a female end with receiving holes for industry standard spring locking pins found on most swimming pool cleaning and maintenance devices.

FIG. 3 shows a right angled pole end connector for pool cleaning where a long handled pole is connected to one end and a skimmer net is connected to the opposite end where the skimmer net is being tossed out onto the surface of a pool.

FIG. 4 shows a standard long handled pole connected directly to a skimmer net in a straight out orientation between the pole handle and the skimmer net.

FIG. 5 shows an operator walking parallel to the edge of a swimming pool pulling a long handled pole connected to a standard skimmer net in a 90 degree orientation to the pole handle with an inward angle of attack of the skimmer net relative to the sidewall of the pool.

FIG. 6 shows an operator sidestepping parallel to the edge of a swimming pool manipulating a long handled pole connected directly (without pole end connector) to a standard skimmer net in a straight out configuration where the skimmer net is aligned parallel to the pole.

FIG. 7 shows the connector apparatus with two devices attached where one device is a float attached in an orientation aligned with a pole handle and the other device is a skimmer net attached in an orientation 90 degrees to a pole handle.

FIG. 8 shows an exploded view of a pole end connector with a male end for connecting to a long handled pole and two female ends for receiving various devices with one female end in an orientation aligned with a pole handle and the other female end in an orientation 90 degrees to a pole handle.

FIG. 9 shows an apparatus with a float attached at one end in an orientation aligned with a handle, a male end (including spring locking pins) for connecting to a handle and a female connector for receiving various devices in an orientation 90 degrees to a handle.

FIG. 10 shows two pole end connectors assembled in a series to give a complex multidimensional angle between a handle and an attached device.

FIGS. 11a, 11b, 11c, 11d and 11e show various additional connector apparatus configurations allowing multiple device attachments to be connected to a handle at the same time.

FIGS. 12a, 12b, 12c, and 12d and show various examples of pole end connection devices using a threaded means of attachment useful in various industries.

FIG. 13 shows pole end connectors used in a boat cleaning process where the attached device (a brush) is orientated at 45 degree and 90 degree angles to the long handled pole.

FIG. 14 shows pole end connectors where a shorter extension is connected between the pole end connector and the attached device for use in difficult to reach areas.

FIG. 15 shows a pole end connector joining two long handled poles in a 90 degree configuration for use in a measuring process in difficult to reach areas.

### DETAILED DESCRIPTION OF THE INVENTION

Herein is a description of an inventive pole connection apparatus which allows the user of tools equipped to a handle to quickly and easily attach and detach a particular tool, and to switch from one tool to another. Typical useful embodiments of the pole connection apparatus allow for at least one tool to be connected at a non-linear angle relative to the handle, such as perpendicular to a pole handle. In the present disclosure herein is a detailed description of a particularly useful embodiment of the pole connection apparatus. The example embodiment will describe the pole connector in usage with a common swimming pool skimmer, and where the handle is a common pole handle such as is used in the swimming pool cleaning industry. Many other embodiments of usage of a quick change pole connector apparatus can be built which are known or could be realized by those skilled in related arts of using handles and attachments for them, and which are intended to fall within the scope of the present pole pivot invention.

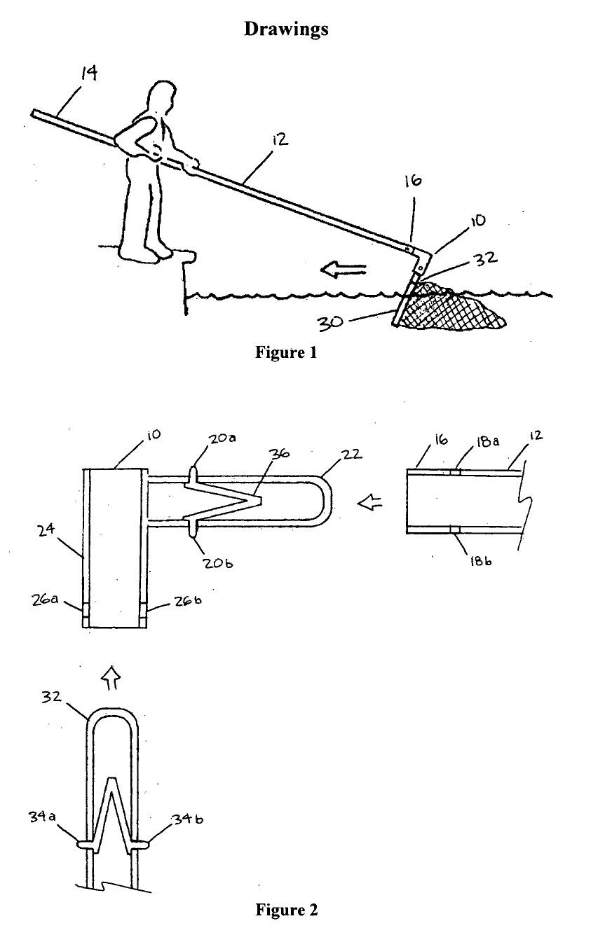

In one first preferred embodiment, as shown in FIG. 1, an angled pole connection apparatus 10, can be built to fit with and connect to a swimming pool cleaning pole handle 12. In this example, the angled connector 10 provides for an angle of approximately 90 degrees between a pole 12 and a swimming pool cleaning device to be connected. Such swimming pool cleaning device pole handles 12 are approximately 1.125 inches inside diameter and are typically made of aluminum tubing. These poles 12 usually have two ends, a handle end 14, and a device connection end 16.

As shown in FIG. 2, these types of poles 12 often have an industry standard female connection site on the device connection end 16, which comprises a pair of connection snap pin holes 18a and 18b which are designed to align with and connect with a pair of connection snap pins 20a and 20b built into the male connection end 22 of a device to be connected to said pole 12.

The inventive connector apparatus of the present example 10 comprises such a male pole connection end portion 22 which can be attached to a female pole end 16, and the inventive connector apparatus 10 further comprises a female device attachment connection end portion 24, onto which one of many various types of useful swimming pool cleaning devices can be attached. The female end portion 24 of said connector apparatus 10 also can have a pair of snap pin connector holes 26a and 26b, which would typically be identical in dimension and relative position to the holes 18a & 18b found on the connection end 16 of said pole 12.

Swimming pool cleaning devices such as a pool surface skimmer 30 as shown in FIG. 1 are typically provided with a male type connection end 32, approximately 1.125 inches outside diameter, sized to fit into the connection end 16 of the pole 12. The female connection end portion 24 of said connector 10 is sized and dimensioned to approximately the size and dimensions of a female end 16 of a pole 12. Thus the male end 32 of a cleaning device 30 can fit into either a female connection end 16 of a pole 12, or into a female connection end portion 24 of the inventive connector apparatus 10. As shown in FIG. 2, when the male end 32 of a device 30 is inserted into the female end portion 24 of said connector device 10, the holes 26a & 26b can be aligned with snap pins 34a and 34b on the male end 32 of the cleaning device 30, to secure the connection between said parts 10 and 30.

The connection snap pins 20a & 20b are often spring loaded, made of a wishbone shaped plastic piece 36 with each of the pair of snap pins 20a & 20b on either end of the wishbone shaped plastic piece 36, although obviously other types of spring loaded snap pin mechanisms could be used. When the connection snap pins 20a & 20b on wishbone shaped plastic piece 36 in the connector 10 are aligned with the snap pin holes 18a & 18b in the connection end 16 of the pole 12, they will snap into place locking the pole 12 to the inventive connector apparatus 10.

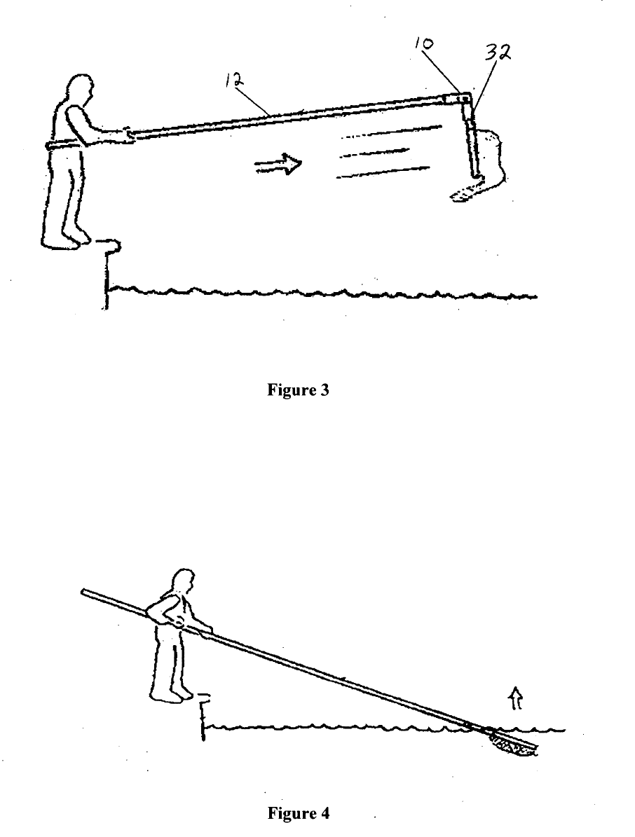

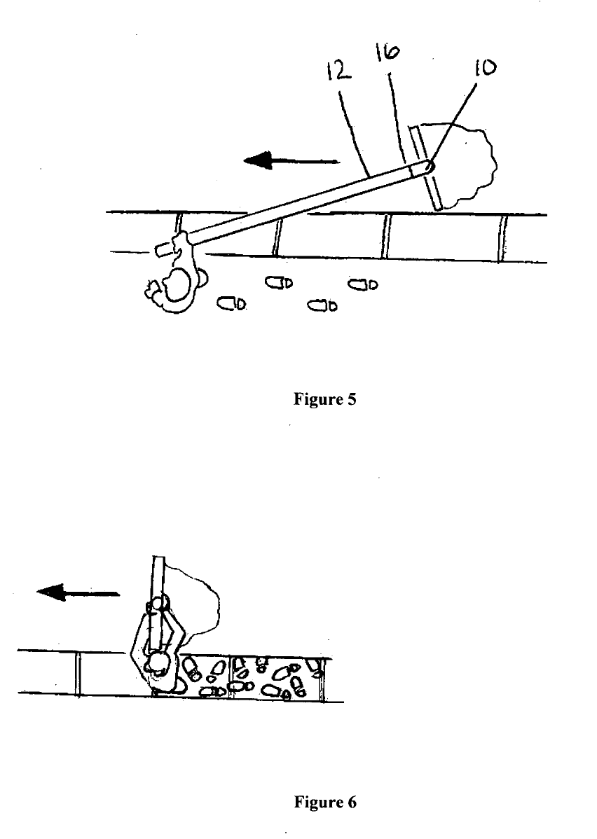

This first embodiment of a pole connector 10 used for swimming pool skimming is demonstrated in FIG. 1, FIG. 3, and FIG. 5. Similar swimming pool skimming operations without the use of said inventive angled connector are shown in FIG. 4 and FIG. 6. The operations of skimming the surface of a swimming pool are made easier and more effective with the use of the inventive angled connector 10.

The quick change pole end attachment connector 10 can be made of plastic or metal or other types of materials which are suitably strong, lightweight, and waterproof. In the preferred embodiment for use in the swimming pool industry, said apparatus 10 including the male connector end portion 22 and female connector end portion 24 are made of molded plastic and the wishbone shaped plastic piece 36 with each of the pair of snap pins 20a & 20 is made of nylon-type molded plastic. The apparatus or some portion of the apparatus could also be made of aluminum tubing, to match various sets of industry standard dimensions and connection methods. Naturally, other materials, such as metal, wood, plastic, Plexiglas, rubber, or any material suitable for construction and durable enough for usage of the device, can also be employed. Other methods of connector attachment could also be employed, such as using threaded connections, push-twist lock methods, straight-through pins, screws, bolts or other connectors.

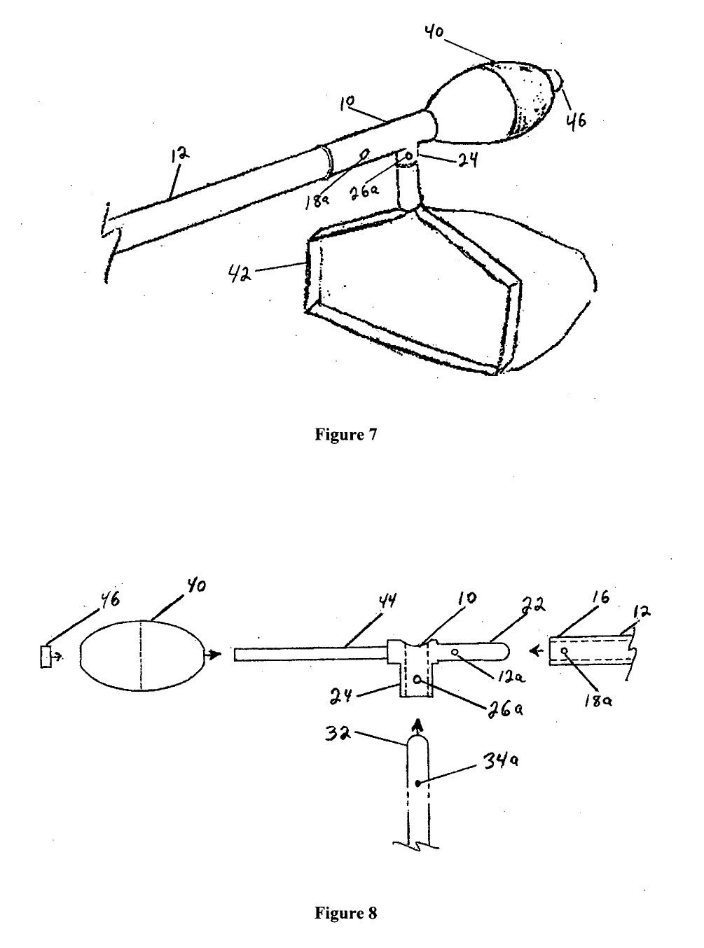

In yet another highly useful set of embodiments, two or more devices can be attached at the same time. Thus for example as shown in FIG. 7, a floatation device 40 and a skimmer 42 can both be attached to certain embodiments of the inventive apparatus 10 at the same time, which is then in turn attached to a handle 12 such as a long poled handle. An efficient method to use this such arrangement of handle 12, connector apparatus 10, and two attached devices, is where the apparatus 10 is turned such that the skimmer 42 faces upwards, out of the water, the pole 12 is used to push the apparatus 12 with skimmer 42 and float 40 attached far out across the surface of a pool to a desired location. Next the pole handle 12 is rotated to allow the skimmer 42 to extend downwards into the water, and the floating skimmer 42 and apparatus 10 can easily then be pulled back across the surface, gathering the desired floating leaves or such debris.

FIG. 8 shows a particular way in which such an embodiment can be made to attach an industry standard float to an apparatus, along with another second device, where the apparatus is capable of being manufactured as a one piece molded plastic component, to which a snap pin connector assembly can be added. The float 40 can be slid onto a float rod 44 which in this example embodiment is aligned directed along the axis of the pole handle 12. An end cap 46 to can be threaded or glued into place on the end of the rod 44 to retain such a float onto a float rod 44 extending from the body of the apparatus 10. Other floatation devices and orientation not shown are also possible within the scope of this invention.

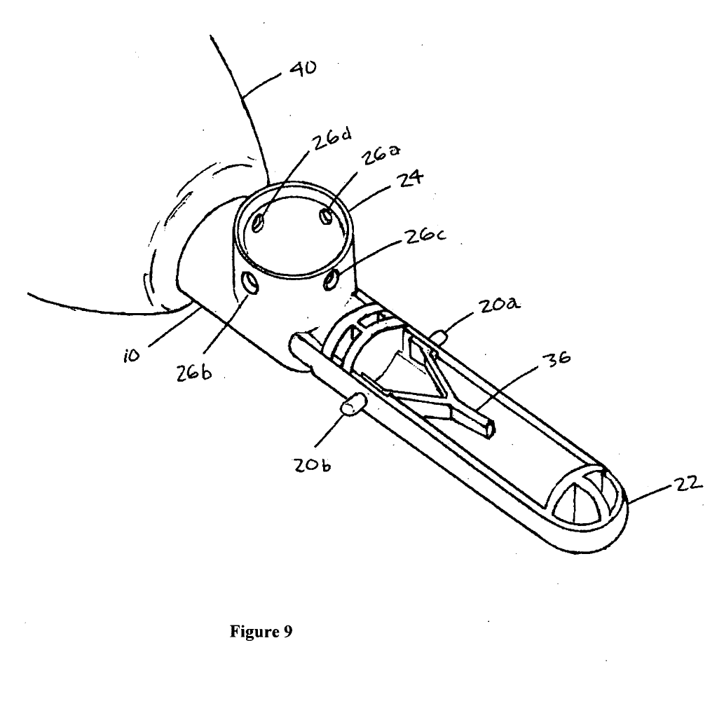

FIG. 9 shows a zoomed in view of this such embodiment of this apparatus 10, where the attachment site 24 has four snap pin holes 26a, 26b, 26c, and 26d, instead of two which allows a device to be attached in different orientations at right angles to each other.

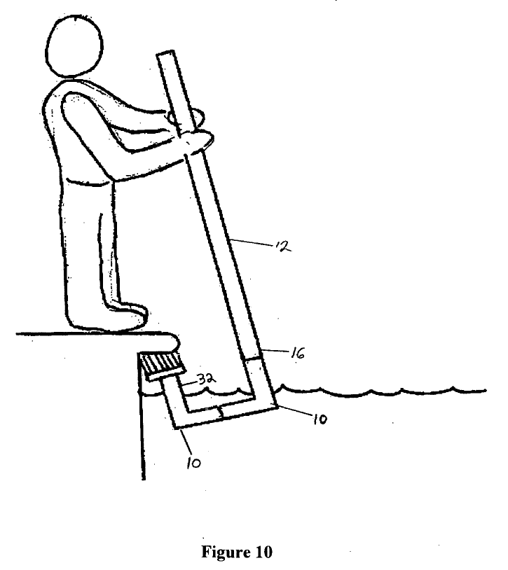

As shown in FIG. 10, several pole end connectors can be assembled in series to give a complex multidimensional angle between a handle and an attached device.

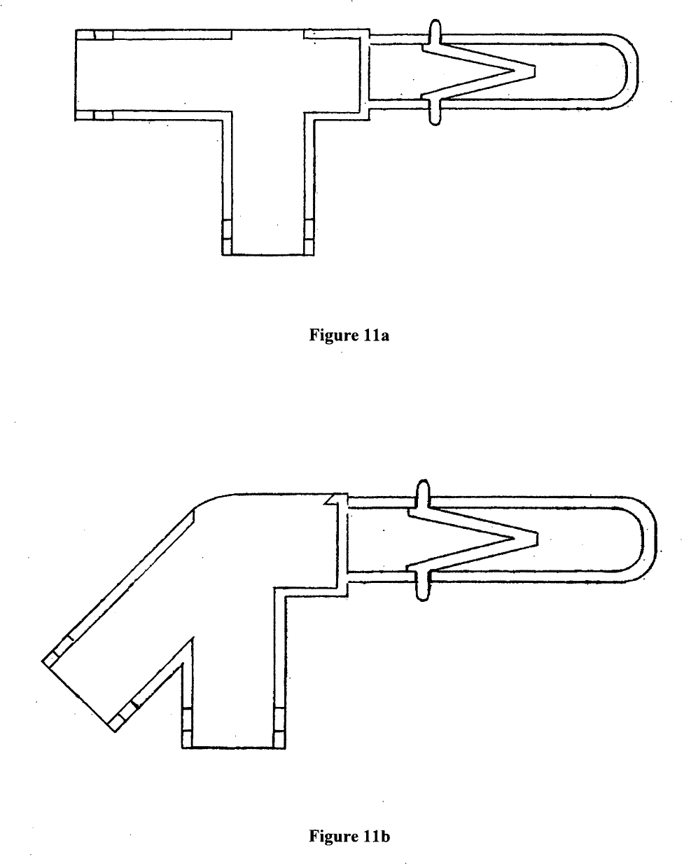

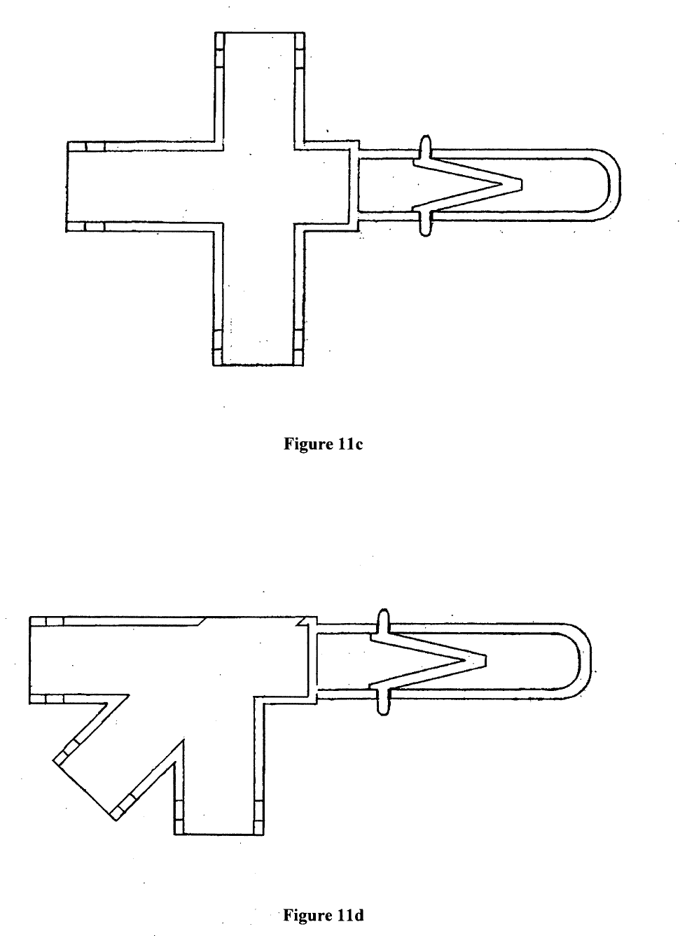

FIGS. 11a, 11b, 11c, 11d and 11e show various additional connector apparatus configurations allowing multiple device attachments to be connected to a handle at the same time. Obviously many other variations are possible, including embodiments where a handle is permanently attached to a connector apparatus, and other embodiments where a device is permanently attached to a connector apparatus.

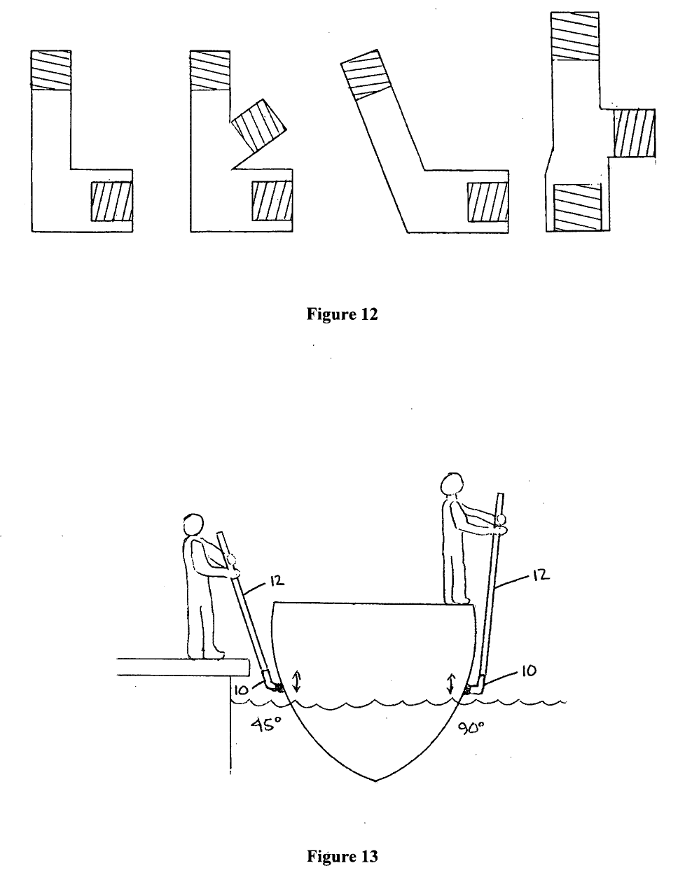

FIGS. 12a, 12b, 12c, and 12d and show various examples of pole end connection devices 10 using a threaded means of attachment in various orientations which might be useful in various industries.

FIG. 13 shows pole end connectors 10 used in a boat cleaning process where the attached device (a brush) is orientated at 45 degree and 90 degree angles to the long handled pole 12.

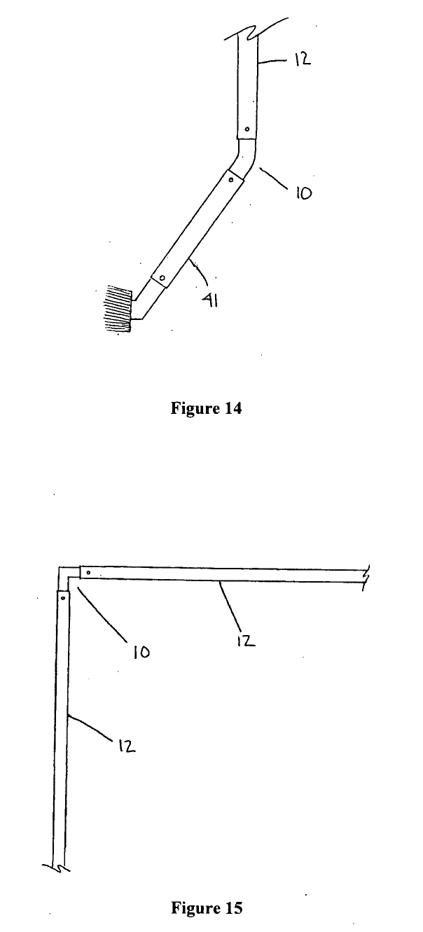

FIG. 14 shows a pole end connector 10 where a shorter extension pole 41 is connected between the pole end connector 10 and the attached device for use in difficult to reach areas.

FIG. 15 shows a pole end connector 10 joining two long handled poles 12 in a 90 degree configuration can be useful for a measuring process in difficult to reach areas.

What is claimed

1) A pole connection apparatus comprising;
A pole connection portion, and at least one device attachment connection portion, where said pole connection portion and at least one device attachment connection portion are at a non-linear angle relative to each other:

2) A pole connection apparatus as in claim 1 where the angle between the pole connection portion and one device attachment connection portion is approximately 90 degrees.

3) A pole connection apparatus as in claim 1 where the angle between the pole connection portion and one device attachment connection portion is between 45 degrees and 135 degrees.

4) A pole connection apparatus as in claim 1 where the pole connection portion comprises a male type fitting approximately 1.125″ diameter.

5) A pole connection apparatus as in claim 4 where the male type pole connection portion further comprises at least one connection securing snap pin.

6) A pole connection apparatus as in claim 1 where at least one device attachment connection portion comprises a female type fitting approximately 1.125″ diameter.

7) A pole connection apparatus as in claim 1 where the pole attachment portion is permanently affixed to a pole.

8) A pole connection apparatus as in claim 1 where the device comprises an attached floatation device and at least one device attachment connection portion.

9) A pole connection apparatus as in claim 8 where the device attachment connection portion is offset approximately 90 degrees angle from the pole connection portion.

10) A pole connection apparatus comprising;
A pole connection portion, at least one device attachment connection portion, and an attached floatation device, where said pole connection portion comprises a male type pole connection portion approximately 1.125″ diameter, and where and at least one device attachment connection portion is at a non-linear angle relative to said pole connection portion.

11) A pole connection apparatus as in claim 10 where said male type pole connection portion further comprises at least one connection securing snap pin.

12) A pole connection apparatus as in claim 10 where said male type pole connection portion further comprises a wishbone shaped piece with each of a pair of snap pins at either end of the wishbone shaped piece.

13) A pole connection apparatus as in claim 10 where said pole connection apparatus is made at least partly of molded plastic.

14) A pole connection apparatus as in claim 10 where said pole connection apparatus further comprises a means of connection with a combination of attachment methods commonly used in various industries.
